(19) United States
(12) Patent Application Publication
(10) Pub. No.: US 2023/0030693 A1
(43) Pub. Date: Feb. 2, 2023

(54) TIRE

(71) Applicant: BRIDGESTONE CORPORATION, Tokyo (JP)

(72) Inventor: Yosuke SASAKI, Tokyo (JP)

(73) Assignee: BRIDGESTONE CORPORATION, Tokyo (JP)

(21) Appl. No.: 17/785,489

(22) PCT Filed: Dec. 2, 2020
(86) PCT No.: PCT/JP2020/044850

§ 371 Date: Jun. 15, 2022

(30) Foreign Application Priority Data
Dec. 16, 2019 (JP) 2019-226450

(51) Int. Cl. B60C 9/22; D02G 3/04; D02G 3/26; D02G 3/48

(52) U.S. Cl. CPC B60C 9/22; D02G 3/045; D02G 3/26; D02G 3/48; D10B 2505/022; D10B 2331/02

(57) ABSTRACT

Provided is a tire in which low rolling resistance is improved by using reinforcing cords containing polyamide multifilaments as reinforcing cords of a reinforcing member of the tire. In a tire (10) that includes at least one belt reinforcing layer (3) covering the full width of a belt (2), the belt reinforcing layer (3) includes, as a constituent, a rubber-cord composite that is formed of a rubber and reinforcing cords containing multifilaments of a semi-aromatic polyamide composed of a polycondensate of an aromatic dicarboxylic acid-containing dicarboxylic acid and a non-aromatic diamine, or a polycondensate of a non-aromatic dicarboxylic acid and an aromatic diamine-containing diamine acid; and, when the width of a maximum-width belt layer constituting the belt (2) is defined as W, a region of at least more than 0.35 W from a tire equatorial plane is a sparse region in terms of the end count of the reinforcing cords in the belt reinforcing layer (3), while regions on the tire width-direction outer side of the sparse region are dense regions.

### TECHNICAL FIELD

The present invention relates to a tire, more particularly a tire in which low rolling resistance is improved by using reinforcing cords containing polyamide multifilaments as reinforcing cords of a reinforcing member of the tire.

### BACKGROUND ART

In recent years, environmental problems such as global warming due to the increase in CO₂ emissions as well as resource depletion problems have become increasingly serious. Accordingly, tires are demanded to be lightweight and fuel-efficient. With regard to tires, rubber properties such as shape, structure, and tread have been actively improved and developed, and weight reduction and improvement in fuel efficiency have been achieved by, for example, a reduction in the usage of rubber and a reduction in the tire rolling resistance. As for the rolling resistance, rubber members are of great involvement; therefore, for example, reduction in the loss of rubber members themselves, such as tread rubber, bead filler rubber, belt coating rubber, and bead filler rubber, as well as reduction in the strain of shapes, structures and the like of rubber members have been studied and optimized.

Further, lately, with the progress of reduction in the loss of rubber members themselves, the contribution of the loss of members other than rubber members caused by dynamic cyclic strain to the rolling resistance can no longer be ignored. Examples of the members other than rubber members include carcass ply layers, belt layers, and belt reinforcing layers and, thereamong, belt reinforcing layers exhibit a large strain fluctuation during rolling and contact with the ground; therefore, a technology for reducing the loss of such belt reinforcing layers is desired. Under these circumstances, Patent Document 1 proposes a reinforcing cord material which can be suitably used as a cap ply layer (belt reinforcing layer) in a tire and has excellent mechanical properties such as rigidity as well as excellent thermal characteristics, and in which only the loss is reduced.

### RELATED ART DOCUMENT

### Patent Document

[Patent Document 1] JP 2002-103913A

### SUMMARY OF THE INVENTION

### Problems to be Solved by the Invention

At present, organic fibers of polyester, rayon, nylon and the like are used in reinforcing members of tires. Thereamong, nylon fibers, which are polyamide fibers, are advantageous in that they exhibit superior adhesion to rubber and superior fatigue resistance than other types of fibers. However, this is not necessarily sufficient for low fuel consumption, and a further improvement in the rolling resistance is demanded at present.

In view of the above, an object of the present invention is to provide a tire in which low rolling resistance is improved by using reinforcing cords containing polyamide multifilaments as reinforcing cords of a reinforcing member of the tire.

### Means for Solving the Problems

The present inventor intensively studied to solve the above-described problems and consequently discovered that the problems can be solved by using reinforcing cords containing multifilaments of a polyamide having a predetermined molecular structure as reinforcing cords of a belt reinforcing layer and adopting a predetermined constitution for the belt reinforcing layer, thereby completing the present invention.

That is, the tire of the present invention is a tire including: a belt including at least one belt layer on the tire radial-direction outer side of a carcass; and at least one belt reinforcing layer covering the full width of the belt on the tire radial-direction outer side of the belt, which tire is characterized in that:

the belt reinforcing layer includes, as a constituent, a rubber-cord composite that is formed of a rubber and reinforcing cords containing multifilaments of a semi-aromatic polyamide composed of a polycondensate of an aromatic dicarboxylic acid-containing dicarboxylic acid and a non-aromatic diamine, or a polycondensate of a non-aromatic dicarboxylic acid and an aromatic diamine-containing diamine; and

when the width of a maximum-width belt layer constituting the belt is defined as W, a region of at least more than 0.35 W from a tire equatorial plane E is a sparse region in terms of the end count of the reinforcing cords in the belt reinforcing layer, while regions on the tire width-direction outer side of the sparse region are dense regions.

In the tire of the present invention, the sparse region is preferably in a range of 0.45 W or less from the tire equatorial plane. In the tire of the present invention, it is preferred that the semi-aromatic polyamide be a polycondensate of an aromatic dicarboxylic acid-containing dicarboxylic acid and a non-aromatic diamine, and that the non-aromatic diamine be at least one of an aliphatic diamine and an alicyclic diamine. In the tire of the present invention, it is also preferred that the reinforcing cords taken out of the tire have a glass transition temperature of 80 to 230° C. Further, in the tire of the present invention, it is preferred that the reinforcing cords taken out of the tire have a ratio between the dynamic elastic modulus E′ (100° C.) at 100° C. and the dynamic elastic modulus E′ (25° C.) at 25° C., E′ (100° C.)/E′ (25° C.), of 0.7 to 1.0. Still further, in the tire of the present invention, it is preferred that the reinforcing cords taken out of the tire have a water content of 0.1 to 2.0% by mass.

Yet still further, in the tire of the present invention, it is preferred that the reinforcing cords taken out of the tire have a ratio between the loss tangent tan δ (25° C.) at 25° C. and the loss tangent tan δ (100° C.) at 100° C., tan δ (25° C.)/tan δ (100° C.), of 0.7 to 1.0. Yet still further, in the tire of the present invention, it is preferred that the loss tangent tan δ (25° C.) at 25° C. of the reinforcing cords taken out of the tire be 0.01 to 0.06. Yet still further, in the tire of the present invention, it is preferred that a ratio of the aromatic dicarboxylic acid with respect to the dicarboxylic acid in the reinforcing cords be 50% by mole or higher. Yet still further, in the tire of the present invention, reinforcing cords in which a ratio of a dicarboxylic acid having one aromatic ring with respect to the aromatic dicarboxylic acid is 20% by mole or higher, a ratio of a dicarboxylic acid having two aromatic rings with respect to the aromatic dicarboxylic acid is 20% by mole or higher, or a ratio of a dicarboxylic acid having three aromatic rings with respect to the aromatic dicarboxylic acid is 20% by mole or higher can be preferably used. Yet still further, in the tire of the present invention, it is preferred that a ratio of a diamine having 7 to 12 carbon atoms with respect to the diamine be 20% by mole or higher. Yet still further, in the tire of the present invention, it is preferred that the reinforcing cords be hybrid cords composed of multifilaments of the above-described polyamide and at least one type of fibers selected from the group consisting of polyester fibers, nylon fibers, aramid fibers, polyketone fibers, glass fibers, carbon fibers, poly-p-phenylene benzobisoxazole fibers, and polyarylate fibers.

Moreover, in the tire of the present invention, it is preferred that the reinforcing cords taken out of the tire have a primary twist coefficient α1 and a final twist coefficient α2, which are represented by the following Formulae (1) and (2), of 0.1 to 0.9 and 0.1 to 1.2, respectively:

α1=N1×√(0.125×D1/ρ)×10⁻³ (1)

α2=N1×√(0.125×D2/ρ)×10⁻³ (2)

(wherein, N1 represents the number of primary twists [twists/10 cm], D1 represents the fineness [dtex] of a single primary-twisted yarn, N2 represents the number of final twists [twists/10 cm], D2 represents the cord total fineness [dtex], and ρ represents the density [g/cm³] of the reinforcing cords).

Further, in the tire of the present invention, it is preferred that the α1 be 0.1 to 0.5 and the α2 be 0.1 to 0.7. Still further, in the tire of the present invention, it is preferred that the total fineness of the reinforcing cords be 1,000 to 8,000 dtex. Yet still further, in the tire of the present invention, it is preferred that the number of primary twists N1 of the reinforcing cords be 10 to 30 twists/10 cm.

The tire of the present invention is suitable as a tire of a passenger vehicle.

It is noted here that the tans of the reinforcing cords is a value measured using a REOLOGRAPH-SOLID, a RHEOVIBRON, a spectrometer, a METRAVIB or the like at a reinforcing cord length of 5 cm under a predetermined temperature with the following conditions: measurement frequency=10 Hz, static tension=100 g, and dynamic cyclic strain=1,000 μm. Further, the glass transition temperature (Tg) is a value measured by differential scanning calorimetry (DSC). The dynamic elastic modulus E′ of the reinforcing cords can be measured under the same conditions as in the measurement of the tan δ. Moreover, the phrase “a ratio of a dicarboxylic acid having one aromatic ring with respect to the aromatic dicarboxylic acid is 20% by mole or higher” used herein means that “a ratio of a structural unit derived from the aromatic dicarboxylic acid with respect to a structural unit derived from a raw material monomer component is 10% by mole or higher”. The phases “a ratio of a dicarboxylic acid having two aromatic rings with respect to the aromatic dicarboxylic acid is 20% by mole or higher”, “a ratio of a dicarboxylic acid having three aromatic rings with respect to the aromatic dicarboxylic acid is 20% by mole or higher”, and “a ratio of a diamine having 7 to 12 carbon atoms with respect to the diamine is 20% by mole or higher” also have comparable meanings.

### Effects of the Invention

According to the present invention, a tire in which low rolling resistance is improved by using reinforcing cords containing polyamide multifilaments as reinforcing cords of a reinforcing member of the tire can be provided.

### BRIEF DESCRIPTION OF THE DRAWINGS

FIG. 1 is a widthwise schematic cross-sectional view of a tire according to one preferred embodiment of the present invention.

### MODE FOR CARRYING OUT THE INVENTION

The tire of the present invention will now be described in detail referring to the drawing.

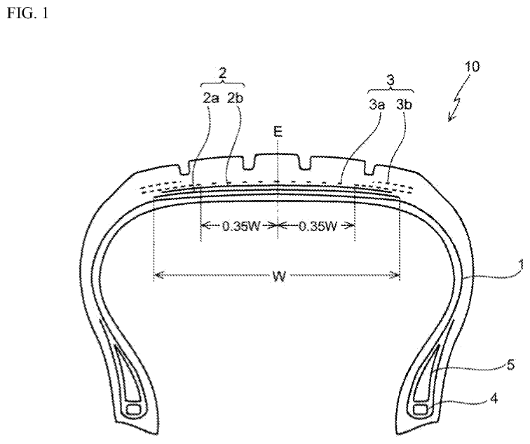

FIG. 1 is a widthwise schematic cross-sectional view of a tire according to one preferred embodiment of the present invention. A tire 10 of the present invention is a tire including: a belt 2 including at least one belt layer on the tire radial-direction outer side of a carcass 1; and at least one belt reinforcing layer 3 covering the full width of the belt 2 on the tire radial-direction outer side of the belt 2. In the illustrated example, the carcass 1 extending between a pair of bead cores 4 is constituted by a single carcass ply; the belt 2 is constituted by two belt layers 2a and 2b; and a bead filler 5 is arranged on the tire radial-direction outer side of each bead core 4.

In the illustrated example, the belt reinforcing layer 3 is constituted by: a cap layer 3a arranged in such a manner to cover the entirety of the belt 2; and a pair of layered layers 3b arranged in such a manner to cover only the respective end portions of the cap layer 3a. The cap layer 3a is arranged such that it intersects with a tire equatorial plane E and continuously extends from one half of the tire to the other half of the tire, whereas the pair of the layered layers 3b are arranged such that they cover only the end portions of the cap layer 3a on each half of the tire, without intersecting with the tire equatorial plane E. In the tire 10 of the present invention, the belt reinforcing layer 3 may include both the cap layer 3a and the layered layers 3b, or may consist of only the cap layer 3a. Further, the cap layer 3a may be provided in two or more layers, and may be provided in combination with two or more layered layers 3b. The belt reinforcing layer 3 is usually composed of a rubberized layer of cords that are arranged substantially parallel to the tire circumferential direction.

In the tire 10 of the present invention, at least one belt reinforcing layer 3 covering the full width of the belt 2 includes, as a constituent, a rubber-cord composite that is formed of a rubber and reinforcing cords containing multifilaments of a semi-aromatic polyamide composed of a polycondensate of an aromatic dicarboxylic acid-containing dicarboxylic acid and a non-aromatic diamine, or a polycondensate of a non-aromatic dicarboxylic acid and an aromatic diamine-containing diamine. In the reinforcing cords, a dicarboxylic acid may contain an aromatic dicarboxylic acid, and a diamine may contain an aromatic diamine; however, the reinforcing cords are particularly preferably those cords that contain multifilaments of a semi-aromatic polyamide in which a dicarboxylic acid contains an aromatic dicarboxylic acid and at least one of an aliphatic diamine and an alicyclic diamine is used as a diamine. As the reinforcing cords of the belt reinforcing layer 3, nylon 66 cords are generally used; however, since such reinforcing cords have a low glass transition temperature Tg (50° C.) and thus have a low rigidity at high temperature, excellent steering stability cannot be obtained. Meanwhile, reinforcing cords using aramid fibers can ensure rigidity at high temperature; however, they have a problem in that their excessively high rigidity markedly deteriorates the tire productivity.

In contrast, a semi-aromatic polyamide has not only a high Tg due to intermolecular interaction but also a moderate rigidity; therefore, the use thereof as the reinforcing cords of the belt reinforcing layer 3 enables to improve the durability and the steering stability during high-speed running, without deteriorating the tire productivity. In addition, a semi-aromatic polyamide has a small loss tangent tans in the tire usage range, and is thus advantageous for reducing the rolling resistance of the tire. Moreover, polyamide fibers composed of an alicyclic dicarboxylic acid and an aliphatic diamine are highly water-absorbing and have poor physical property stability. On the other hand, semi-aromatic polyamide fibers have a low water-absorbing property and can thus ensure stable physical properties.

Further, in the tire 10 of the present invention, when the width of a maximum-width belt layer constituting the belt 2 is defined as W, the reinforcing cords contained in the belt reinforcing layer 3 are sparse in a region of at least more than 0.35 W from the tire equatorial plane E (sparse region), while the reinforcing cords are dense in regions on the tire width-direction outer side of this sparse region (dense regions). By reducing the end count of the reinforcing cords in the belt reinforcing layer 3 in the vicinity of the tire equatorial plane E of the tire 10 in this manner, a reduction in the rolling resistance can be realized. A reduction in the end count is expected to lead to a reduction in weight as well. In order to obtain these effects in a favorable manner, it is preferred to control the end count of the reinforcing cords to be low in a range of at least 0.40 W from the tire equatorial plane E. Meanwhile, from the standpoint of durability, the range of the sparse region is preferably 0.45 W or less from the tire equatorial plane E. When the range of the sparse region extends farther outside than 0.45 W from the tire equatorial plane, the durability of the tire may be deteriorated. In view of this standpoint, the range of the sparse region is more preferably less than 0.45 W.

In the tire 10 of the present invention, the end count of the reinforcing cords in the sparse region is preferably 25 to 75% of that in the dense regions. By satisfying this range, the weight and the rolling resistance of the tire can be sufficiently reduced without deteriorating various performance of the tire. In order to obtain this effect in a more favorable manner, the end count of the reinforcing cords in the sparse region of the belt reinforcing layer 3 is more preferably 40 to 60% of that in the dense regions.

The belt reinforcing layer 3 can be formed by spirally winding a ribbon-like strip, which is obtained by rubber-coating cords containing the multifilaments of a semi-aromatic polyamide according to the present invention, along the tire circumferential direction. In this process, the end count of the reinforcing cords can be reduced by widening the winding interval of the ribbon-like strip, or the end count of the reinforcing cords can be increased by narrowing the winding interval of the ribbon-like strip.

In the tire 10 of the present invention, the reinforcing cords taken out of the tire 10 preferably have a Tg of 80 to 230° C. By using cords having a high Tg as the reinforcing cords of the belt reinforcing layer 3 in this manner, the loss tangent tans in the tire usage range can be reduced, so that the rolling resistance of the tire 10 can be improved. In addition, since rigidity can be ensured at high temperatures as well, the steering stability at high speed can be improved. The Tg is preferably 100 to 160° C.

In addition, in the tire 10 of the present invention, it is preferred that the reinforcing cords taken out of the tire 10 have a ratio between the loss tangent tan δ (25° C.) at 25° C. and the loss tangent tan δ (100° C.) at 100° C., tan δ (25° C.)/tan δ (100° C.), of 0.7 to 1.0. Particularly, the loss tangent tan δ (25° C.) at 25° C. of the reinforcing cords taken out of the tire is preferably 0.01 to 0.06. Such reinforcing cords have a small tans at high temperature and can thus inhibit the generation of heat, so that the durability of the tire at high speed can be improved. The value of tan δ (25° C.)/tan δ (100° C.) is preferably 0.85 to 1.0.

Further, in the tire 10 of the present invention, it is preferred that the reinforcing cords taken out of the tire 10 have a ratio between the dynamic elastic modulus E′ (25° C.) at 25° C. and the dynamic elastic modulus E′ (100° C.) at 100° C., E′ (100° C.)/E′ (25° C.), of 0.7 to 1.0. By controlling the value of E′ (100° C.)/E′ (25° C.) to be in this range, the steering stability at high temperature can be further improved. Particularly, the dynamic elastic modulus E′ (25° C.) at 25° C. of the reinforcing cords taken out of the tire is preferably 0.7 to 0.8.

Still further, in the tire 10 of the present invention, it is preferred that the reinforcing cords taken out of the tire 10 have a water content of 0.1 to 2.0% by mass. As described above, the semi-aromatic polyamide fibers according to the reinforcing cords of the tire 10 of the present invention have a low water-absorbing property and can thus ensure stable physical properties. Particularly, the effects of the present invention can be favorably obtained when the water content is 0.1 to 2.0% by mass.

It is noted here that the values of tan δ (25° C.)/tan δ (100° C.) and E′ (100° C.)/E′ (25° C.) of the reinforcing cords can be adjusted by appropriate selecting the type and the number of twists of the reinforcing cords, the conditions for immersing the reinforcing cords in an adhesive applied to their surfaces, the type of the adhesive, and the conditions of a heat treatment after the treatment with the adhesive. Further, in the tire 10 of the present invention, the end count of the reinforcing cords in the belt reinforcing layer 3 can be set as appropriate in accordance with the strength of the reinforcing cords; however, the end count in the dense regions is preferably 20 to 100 cords/50 mm, more preferably 30 to 80 cords/50 mm, still more preferably 40 to 60 cords/50 mm.

In the tire 10 of the present invention, it is preferred that the reinforcing cords taken out of the tire 10 have a primary twist coefficient al and a final twist coefficient α2, which are represented by the following Formulae (1) and (2), of 0.1 to 0.9 and 0.1 to 1.2, respectively:

α1=N1×√(0.125×D1/ρ)×10⁻³ (1)

α2=N2×√(0.125×D2/ρ)×10⁻³ (2)

In Formulae (1) and (2), N1 represents the number of primary twists [twists/10 cm]; D1 represents the fineness [dtex] of a single primary-twisted yarn; N2 represents the number of final twists [twists/10 cm]; D2 represents the cord total fineness [dtex]; and ρ represents the density [g/cm³] of the reinforcing cords. By twisting the multifilaments of a semi-aromatic polyamide according to the present invention, the strength utilization rate can be equalized, so that the fatigue characteristics of the filaments are improved. Particularly, by satisfying the above-described conditions, the reinforcing cords can have both satisfactory rigidity and satisfactory fatigue characteristics. It is noted here that the tension during twisting is preferably 0.01 to 0.2 cN/dtex.

Moreover, in the tire 10 of the present invention, it is preferred that the α1 be 0.1 to 0.5 and the α2 be 0.1 to 0.7. By satisfying this condition, the reinforcing cords can have both satisfactory rigidity and satisfactory fatigue characteristics at high levels. Particularly, it is preferred that the number of primary twists N1 and that of the final twists N2 of the reinforcing cords be both 10 to 30 twists/10 cm.

It is preferred that the reinforcing cords according to the tire 10 of the present invention have a total fineness of 1,000 to 8,000 dtex. By controlling the total fineness to be 1,000 dtex or more, a sufficient strength can be ensured. Meanwhile, from the standpoints of spinnability and post-processing, the total fineness is preferably 8,000 dtex or less, more preferably 5,000 dtex or less.

In the tire 10 of the present invention, as the reinforcing cords of the belt reinforcing layer 3, cords consisting of only multifilaments of a semi-aromatic polyamide may be used, or so-called hybrid cords in which other fibers are used in combination may be used as well. The other fibers may be, for example, at least one type of fibers selected from the group consisting of polyester fibers, nylon fibers, aramid fibers, polyketone fibers, glass fibers, carbon fibers, poly-p-phenylene benzobisoxazole fibers, and polyarylate fibers.

Next, materials and production method of cords using the multifilaments of a semi-aromatic polyamide according to the tire 10 of the present invention will be described in detail. The multifilaments of a semi-aromatic polyamide are multifilaments of a polyamide composed of a polycondensate of an aromatic dicarboxylic acid-containing dicarboxylic acid and a non-aromatic diamine, or a polycondensate of a non-aromatic dicarboxylic acid and an aromatic diamine-containing diamine. The dicarboxylic acid may contain an aromatic dicarboxylic acid, and the diamine may contain an aromatic diamine; however, the multifilaments are particularly preferably those multifilaments which are composed of a polyamide containing an aromatic dicarboxylic acid as a dicarboxylic acid and at least one of an aliphatic diamine and an alicyclic diamine as a diamine.

### Dicarboxylic Acid

In the multifilaments of a semi-aromatic polyamide according to the tire 10 of the present invention, the ratio of the aromatic dicarboxylic acid with respect to the dicarboxylic acid is preferably at least 50% by mole or higher, more preferably 60% by mole or higher, still more preferably 70% by mole or higher. By this, the multifilaments of a semi-aromatic polyamide can be provided with a high Tg, a high fiber strength, and excellent spinnability.

The aromatic dicarboxylic acid is not particularly limited and can be selected as appropriate in accordance with the intended purpose, and examples thereof include aromatic dicarboxylic acids having 8 to 20 carbon atoms which are unsubstituted or substituted with various substituents, such as terephthalic acid, isophthalic acid, naphthalenedicarboxylic acid, 2-chloroterephthalic acid, 2-methylterephthalic acid, 5-methylisophthalic acid, and sodium 5-sulfoisophthalate. The aromatic dicarboxylic acid is preferably terephthalic acid. These aromatic dicarboxylic acids may be used singly, or in combination of two or more thereof.

In the multifilaments of a semi-aromatic polyamide according to the tire 10 of the present invention, for example, an alicyclic dicarboxylic acid whose alicyclic structure has 3 to 10 carbon atoms, or a linear or branched aliphatic dicarboxylic acid having 3 to 20 carbon atoms can be used as a dicarboxylic acid other than the aromatic dicarboxylic acid.

Specific examples of the alicyclic dicarboxylic acid whose alicyclic structure has 3 to 10 carbon atoms include 1,4-cyclohexanedicarboxylic acid, 1,3-cyclohexanedicarboxylic acid, and 1,3-cyclopentanedicarboxylic acid. In the reinforcing cords used in the tire 10 of the present invention, the alicyclic dicarboxylic acid may be unsubstituted or have a substituent. Examples of the substituent include, but not limited to: alkyl groups having 1 to 4 carbon atoms, such as a methyl group, an ethyl group, an n-propyl group, an isopropyl group, an n-butyl group, an isobutyl group, and a tert-butyl group. Among the above-described alicyclic dicarboxylic acids, 1,4-cyclohexanedicarboxylic acid is preferred from the standpoints of heat resistance, dimensional stability, strength and the like of the reinforcing cords. These alicyclic dicarboxylic acids may be used singly, or in combination of two or more thereof.

It is noted here that alicyclic dicarboxylic acids have geometric isomers of a trans form and a cis form. For example, 1,4-cyclohexanedicarboxylic acid as a raw material monomer may be used in either the trans form or the cis form, or may be used as a mixture of the trans form and the cis form at various ratios.

Examples of the linear or branched aliphatic dicarboxylic acid having 3 to 20 carbon atoms include, but not limited to: malonic acid, dimethylmalonic acid, succinic acid, 2,2-dimethylsuccinic acid, 2,3-dimethylglutaric acid, 2,2-diethylsuccinic acid, 2,3-diethylglutaric acid, glutaric acid, 2,2-dimethylglutaric acid, adipic acid, 2-methyladipic acid, trimethyladipic acid, pimelic acid, suberic acid, azelaic acid, sebacic acid, dodecanedioic acid, tetradecanedioic acid, hexadecanedioic acid, octadecanedioic acid, eicosanedioic acid, and diglycolic acid.

Generally, an increase in the number of aromatic rings contained in a dicarboxylic acid constituting a polyamide multifilament leads to an increase in the binding strength attributed to interaction of aromatic rings between molecules, and the Tg is thereby increased. Accordingly, the number of aromatic rings contained in the dicarboxylic acid may be adjusted in accordance with the desired durability and steering stability in high-speed running. For example, multifilaments in which a ratio of a dicarboxylic acid having one aromatic ring with respect to the aromatic dicarboxylic acid is 20% by mole or higher, a ratio of a dicarboxylic acid having two aromatic rings with respect to the aromatic dicarboxylic acid is 20% by mole or higher, or a ratio of a dicarboxylic acid having three aromatic rings with respect to the aromatic dicarboxylic acid is 20% by mole or higher can be used as appropriate. It is noted here that, although an increase in the number of aromatic rings contained in a dicarboxylic acid leads to an increase in the melting point (Tm) at the same time and the fiber spinning workability is thus deteriorated, the Tm can be lowered by increasing the number of carbon atoms of a diamine component.

### Diamine

In the multifilaments of a semi-aromatic polyamide according to the tire 10 of the present invention, from the standpoints of spinning stability, heat resistance and low water absorption, a ratio of a diamine having 7 to 12 carbon atoms with respect to the diamine is preferably 20% by mole or higher, more preferably 30% by mole to 80% by mole, still more preferably 40% by mole to 75% by mole, particularly preferably 45% by mole to 70% by mole.

Generally, a polymer having a high TG tends to have a high Tm. When the Tm is excessively high, a polyamide is thermally decomposed during melting and causes a reduction in the molecular weight and the strength, coloration, and contamination with decomposition gas, as a result of which the spinnability is deteriorated. However, by incorporating a diamine having 7 to 12 carbon atoms in an amount of not less than 20% by mole, the Tm can be kept suitable for melt spinning while maintaining a high Tg. In addition, a polyamide containing a diamine having 7 to 12 carbon atoms exhibits high thermal stability during melting and, therefore, can yield a multifilament having excellent spinning stability and good uniformity. Further, by reducing the amide group concentration in such a polyamide, a multifilament having excellent dimensional stability during water absorption can be obtained. Particularly, 1,9-nonanediamine and 1,10-decamethylenediamine are preferred from the standpoint of obtaining both satisfactory spinning stability and satisfactory strength.

Diamines other than 1,9-nonanediamine and 1,10-decamethylenediamine are not particularly limited, and may be unsaturated linear aliphatic diamines, branched aliphatic diamines having a substituent such as an alkyl group having 1 to 4 carbon atoms, or alicyclic diamines. Examples of the substituent include a methyl group, an ethyl group, an n-propyl group, an isopropyl group, an n-butyl group, an isobutyl group, and a tert-butyl group. Examples of diamines other than 1,9-nonanediamine and 1,10-decamethylenediamine include: linear aliphatic diamines, such as ethylenediamine, propylenediamine, tetramethylenediamine, pentamethylenediamine, hexamethylenediamine, heptamethylenediamine, octamethylenediamine, undecamethylenediamine, dodecamethylenediamine, and tridecamethylenediamine; 2-methylpentamethylenediamine; 2,2,4-trimethylhexamethylenediamine; 2-methyloctamethylenediamine; 2,4-dimethyloctamethylenediamine; 1,4-cyclohexanediamine; 1,3-cyclohexanediamine; and 1,3-cyclopentanediamine.

Further, in the multifilaments of a semi-aromatic polyamide according to the tire 10 of the present invention, an aromatic diamine may be added to the diamine within a range that does not impair the fluidity of the polyamide. The term “aromatic diamine” used herein refers to a diamine containing an aromatic group, and examples thereof include, but not limited to: meta-xylylenediamine, ortho-xylylenediamine, and para-xylylenediamine.

As diamines other than 1,9-nonanediamine and 1,10-decamethylenediamine, those which contain a diamine having 5 to 6 carbon atoms at a ratio of 20% by mole or higher are more preferred. By copolymerizing a diamine having 5 to 6 carbon atoms in addition to 1,9-nonanediamine and 1,10-decamethylenediamine, a polymer having a high crystallinity while maintaining a melting point suitable for spinning can be obtained. Examples of the diamine having 5 to 6 carbon atoms include pentamethylenediamine, hexamethylenediamine, 2-methylpentamethylenediamine, 2,5-dimethylhexanediamine, and 2,2,4-trimethylhexamethylenediamine.

Among diamines having 5 to 6 carbon atoms, 2-methylpentamethylenediamine is preferred from the standpoints of spinnability, fluidity, and strength. When the ratio of 2-methylpentamethylenediamine is excessively high, 2-methylpentamethylenediamine undergoes self-cyclization and is decomposed during melting to cause a reduction in the molecular weight, as a result of which the spinnability and the strength are deteriorated. The ratio of 2-methylpentamethylenediamine in the diamine thus needs to be set in a range that does not cause such decomposition during melting while securing fluidity, and the ratio of 2-methylpentamethylenediamine is preferably 20% by mole to 70% by mole, more preferably 20% by mole to 60% by mole, still more preferably 20% by mole to 55% by mole.

Further, among diamines having 5 to 6 carbon atoms, hexamethylenediamine is preferred from the standpoint of the heat resistance of the reinforcing cords according to the tire 10 of the present invention. An excessively high ratio of hexamethylenediamine leads to an excessively high melting point and thus makes it difficult to perform spinning; therefore, the ratio of hexamethylenediamine in the diamine is preferably 20% by mole to 60% by mole, more preferably 20% by mole to 50% by mole, still more preferably 20% by mole to 45% by mole.

The amount of the dicarboxylic acid to be added and that of the diamine to be added are preferably about the same molar amount so as to increase the molecular weight. With regard to the molar ratio, also taking into consideration the portion of the diamine escaping out of the reaction system during polymerization reaction, a total diamine molar amount is preferably 0.90 to 1.20, more preferably 0.95 to 1.10, still more preferably 0.98 to 1.05, with respect to a total dicarboxylic acid molar amount of 1.00.

In the polymerization of a polyamide from the dicarboxylic acid and the diamine, a known end-capping agent may be further added to control the molecular weight. Examples of the end-capping agent include monocarboxylic acids, monoamines, acid anhydrides such as phthalic anhydride, monoisocyanates, monoacid halides, monoesters, and monoalcohols, among which monocarboxylic acids and monoamines are preferred from the standpoint of thermal stability. These end-capping agents may be used singly, or in combination of two or more thereof.

The multifilaments of a semi-aromatic polyamide that constitute the reinforcing cords according to the tire 10 of the present invention preferably has a cross ratio of 1.7 or lower. The “cross ratio” is a value obtained by dividing a maximum diameter of a multifilament by a minimum diameter of the multifilament, and serves as a measure of the uniformity between single filaments. The strength of a multifilament is biased toward a lower side within the strength distribution of single filaments; therefore, strength is not exerted when the single filaments are largely variable. Accordingly, in the multifilaments of a semi-aromatic polyamide according to the tire 10 of the present invention, the cross ratio is preferably 1.7 or lower, more preferably 1.6 or lower, still more preferably 1.5 or lower. By controlling the cross ratio to be 1.7 or lower, stretching is performed uniformly at the single filament level, so that the multifilaments of a semi-aromatic polyamide exerts excellent strength with little variation in the single filament strength. A lower limit of the cross ratio is 1.0.

### Method of Producing Semi-Aromatic Polyamide

Examples of a method of producing a semi-aromatic polyamide include: (1) a method of heating an aqueous solution or aqueous suspension of a dicarboxylic acid and a diamine salt or a mixture thereof, and performing polymerization while maintaining a molten state (hot melt polymerization method); (2) a method of increasing the degree of polymerization while maintaining a polyamide obtained by the hot melt polymerization method to be in a solid state at a temperature of not higher than the melting point (hot melt polymerization-solid phase polymerization method); (3) a method of heating an aqueous solution or aqueous suspension of a diamine and a dicarboxylic acid salt or a mixture thereof, and re-melting the resulting precipitated prepolymer using an extruder such as a kneader to increase the degree of polymerization (“prepolymer extrusion polymerization method”); (4) a method of heating an aqueous solution or aqueous suspension of a diamine and a dicarboxylic acid salt or a mixture thereof, and further increasing the degree of polymerization while maintaining the resulting precipitated prepolymer to be in a solid state at a temperature of not higher than the melting point of the polyamide (“prepolymer solid phase polymerization method”); (5) a method of polymerizing a diamine and a dicarboxylic acid salt or a mixture thereof while maintaining a solid state (“solid phase polymerization method”); and (6) a method of polymerizing a dicarboxylic acid halide component equivalent to a dicarboxylic acid with a diamine component (solution method).

As a method of producing a semi-aromatic polyamide, it is preferred to produce the polyamide by (1) hot melt polymerization method or (2) hot melt polymerization-solid phase polymerization method since it is easy to maintain the trans isomer ratio to be 85% or lower and the resulting polyamide has excellent color tone in these methods. The mode of polymerization may be either a batch type or a continuous type. A polymerization apparatus is not particularly limited, and examples thereof include known apparatuses, for example, an autoclave-type reactor, a tumbler-type reactor, and an extruder-type reactor such as a kneader.

### Multifilaments of Semi-Aromatic Polyamide

The multifilaments of a semi-aromatic polyamide according to the tire 10 of the present invention are obtained by fibrillization of the above-described semi-aromatic polyamide. A variety of method can be employed for the production of the multifilaments of the semi-aromatic polyamide; however, melt spinning is usually employed, and it is preferred to perform the melt spinning using a screw-type melt extruder. The spinning temperature (melting temperature) of the polyamide is preferably 300° C. to 360° C. At a spinning temperature of 300° C. or higher, contamination by unmelted polyamide due to inadequate amount of heat can be inhibited. At a spinning temperature of 360° C. or lower, thermal decomposition of the polymer and generation of decomposition gas can be greatly reduced, so that the spinnability is improved.

In the multifilament cords of semi-aromatic polyamide according to the tire 10 of the present invention, it is preferred to use an adhesive for adhesion of a rubber constituting the tire with the multifilament cords of semi-aromatic polyamide, and this adhesive is preferably a resorcin-formalin-latex solution (RFL solution).

After the RFL solution is adhered, the RFL solution is dried, fixed and then relaxed. The drying temperature of the RFL solution is preferably 120 to 250° C., more preferably 140 to 200° C., and the drying time is preferably 10 seconds or longer, more preferably 20 to 120 seconds. After the drying, the resulting twisted product is continuously heat-treated in a heat setting zone and a normalizing zone. The temperature and the time in the heat setting zone and those in the normalizing zone are preferably 150 to 250° C. and 10 to 300 seconds, respectively. In this process, it is preferred that the twisted product be stretched by 2% to 10%, preferably 3% to 9%.

The tire 10 of the present invention is a tire including: a belt 2 including at least one belt layer on the tire radial-direction outer side of a carcass 1; and at least one belt reinforcing layer 3 covering the full width of the belt 2 on the tire radial-direction outer side of the belt 2, in which tire the at least one belt reinforcing layer 3 covering the full width of the belt 2 includes, as a constituent, a rubber-cord composite that is formed of a rubber and reinforcing cords containing multifilaments of a semi-aromatic polyamide composed of a polycondensate of an aromatic dicarboxylic acid-containing dicarboxylic acid and a non-aromatic diamine, or a polycondensate of a non-aromatic dicarboxylic acid and an aromatic diamine-containing diamine; and, when the width of a maximum-width belt layer constituting the belt 2 is defined as W, a region of at least more than 0.35 W from a tire equatorial plane E is a sparse region in terms of the end count of the reinforcing cords in the belt reinforcing layer 3, while regions on the tire width-direction outer side of this sparse region are dense regions. The tire 10 of the present invention is not particularly limited except for these features, and can adopt any known structure. It is noted here that, in the tire 10 of the present invention, only at least one layer of the belt reinforcing layer 3 needs to be composed of the above-described rubber-cord composite, other layers may have a conventional constitution.

For example, in the example illustrated in FIG. 1, the carcass 1 consists of a single carcass ply; however, in the tire 10 of the present invention, the number of carcass plies is not limited thereto, and the carcass 1 may consist of two or more carcass plies. Further, when a cord other than the above-described cords containing multifilaments of a semi-aromatic polyamide is used as a reinforcing cord of the carcass 1 or the belt reinforcing layer 3, the cord can be a known organic fiber cord, and the cord angle of the carcass can be set at a direction substantially perpendicular to the tire circumferential direction, for example, at 70° to 90°. As the organic cord, any known organic cord that is normally used can be used. For example, a cord made of nylon or polyethylene terephthalate (PET) can be used as well. Moreover, the anchoring structure of the carcass ply in the bead portions is not limited to the one illustrated in the drawing in which the carcass ply is wound up around each bead core 4 and thereby anchored, and the anchoring structure may be one in which each end portion of the carcass ply is sandwiched by two layers of bead core (not illustrated).

In the illustrated tire 10, the belt 2 consists of two belt layers 2a and 2b; however, in the tire 10 of the present invention, the belt 2 may consist of three or more belt layers. Each belt layer may be a rubberized layer of cords extending at an inclination of, for example, ±15° to 40° with respect to the tire circumferential direction, preferably a rubberized layer of metal cords such as steel cords. For example, the illustrate two belt layers 2a and 2b may be intersecting layers that are laminated such that the metal cords constituting the respective belt layers intersect with each other across the tire equatorial plane E. The metal cords may each be a metal cord obtained by twisting together plural metal filaments, or may be a metal cord obtained by bundling plural metal filaments without twisting them together. Further, the plural metal filaments may be arranged parallel to one another without being twisted together and, in such a case, the metal filaments may be straight or patterned.

As a form of the metal cords in which plural metal filaments are arranged parallel to one another without being twisted together, for example, one in which preferably two or more, more preferably five or more, but preferably 20 or fewer, more preferably 12 or fewer, still more preferably 10 or fewer, particularly preferably 9 or fewer metal filaments are arranged parallel as bundles can be adopted.

A rubber-metal cord composite having metal cords in which plural metal filaments are arranged parallel without being twisted together or plural metal filaments are bundled can be produced by any known method. For example, such a rubber-metal cord composite can be produced by parallelly arranging metal cords at predetermined intervals and coating these metal cords from both above and below with sheets that are made of an elastomer and have a thickness of about 0.5 mm. Further, patterning of the metal filaments can be performed in accordance with a conventional method using an ordinary patterning apparatus.

In the tire 10 of the present invention, an inner liner may be arranged as the innermost layer, although it is not illustrated in the drawing. As a gas filled into the tire 10 of the present invention, normal air or an air having an adjusted oxygen partial pressure, or an inert gas such as nitrogen can be used. The tire of the present invention is suitable as a tire of a passenger vehicle.

### EXAMPLES

The tire of the present invention will now be described in more detail by way of Examples.

### Examples and Comparative Examples

Tires of the type illustrated in FIG. 1 were produced at a tire size of 205/55R16. A carcass was constituted by a single layer of carcass ply that was arranged in the direction substantially perpendicular to the tire circumferential direction. The end count of the carcass ply was set at 50 cords/50 mm. Further, as belt reinforcing layers, a single cap layer and a single layered layer were arranged substantially parallel (0° to 5°) to the tire circumferential direction. The constitution of the belt reinforcing layers was as shown in Table 1. In Table 1, “semi-aromatic polyamide” is mainly composed of terephthalic acid and 1,9-diaminenonane. Reinforcing cords had the following physical properties.
Cord structure: 1,400 dtex/2
Ratio of aromatic dicarboxylic acid: 100% by mole
Tg: 139° C.
tan δ (25° C.): 0.05
tan δ (100° C.): 0.05
tan δ (25° C.)/tan δ (100° C.): 1.0
E′ (100° C.) 3.6 GPa
E′ (25° C.) 4.7 GPa
E′ (100° C.)/E′ (25° C.): 0.77
Water content: 1.3% by mass
N1: 26 twists/10 cm
N2: 26 twists/10 cm
α1: 0.32
α2: 0.46

For the thus obtained tires, the rolling resistance was evaluated by the below-described procedure. It is noted here that the Tg, the value of tan δ (25° C.)/tan δ (100° C.), and the value of E′ (100° C.)/E′ (25° C.) of cords composed of multifilaments of a semi-aromatic polyamide were adjusted by adjusting the ratio of an aromatic dicarboxylic acid with respect to a dicarboxylic acid, the number of twists, the conditions for immersing the cords in an adhesive, and the conditions of a heat treatment after the treatment with the adhesive.

### Rolling Resistance

Each tire was mounted on a normal rim defined by JATMA and inflated to a proper internal pressure and, in a drum test conducted at a speed of 80 km/h with a proper load being applied to the tire, the resistance of each tire of Comparative Examples 1 and 2 and Example 1 was directly measured, and the tires of Comparative Examples 3 to 5 and Example 2 were evaluated by estimation based on the measured data. A larger index value indicates a lower and thus superior rolling resistance. The thus obtained results are shown together in Table 1.

### High-Speed Durability

The tires of Comparative Examples 1 and 2 and Example 1 were each mounted on a normal rim defined by JATMA, inflated to a proper internal pressure, and run on a drum tester with a proper load being applied thereto while increasing the speed stepwise by 10 km/h at 20-minute intervals starting from 120 km/h. The speed at which a trouble occurred was measured to evaluate the high-speed durability. Thereafter, for the tires of other than Comparative Examples 1 and 2 and Example 1, the high-speed durability was estimated based on the results obtained for Comparative Examples 1 and 2 and Example 1. The results are presented as index values, taking the measured value of Comparative Example 1 as 100. A larger index value is a more favorable result. The thus obtained results are shown together in Table 1.

TABLE 1

| | | Comparative | | Comparative | Comparative | | |
|---|---|---|---|---|---|---|---|
| | | Example 2 | | Example 4 | Example 5 | Example 1 | Example 2 |
| | Comparative | Semi- | Comparative | Semi- | Semi- | Semi- | Semi- |
| | Example 1 | aromatic | Example 3 | aromatic | aromatic | aromatic | aromatic |
| Cord type | Ny66 | polyamide | Ny66 | polyamide | polyamide | polyamide | polyamide |
| Range of sparse region | — | — | 0.3 W | 0.35 W | 0.35 W | 0.4 W | 0.45 W |
| End count in dense | 50 | 50 | 50 | 50 | 50 | 50 | 50 |
| region | | | | | | | |
| (cords/50 mm) | | | | | | | |
| End count in sparse | — | — | 40 | 30 | 25 | 25 | 25 |
| region | | | | | | | |
| (cords/50 mm) | | | | | | | |
| Rolling resistance | 100 | 107 | 107 | 107 | 107 | 108 | 108 |
| (index) | | | | | | | |
| High-speed durability | 100 | 100 | 100 | 100 | 100 | 100 | 99 |
| (index) | | | | | | | |

Ny66: nylon 66

From Table 1, it is seen that the tire of the present invention has an improved rolling resistance.

### DESCRIPTION OF SYMBOLS

1: carcass
2: belt
3: belt reinforcing layer
4: bead core
5: bead filler
10: tire

1. A tire, comprising:
a belt comprising at least one belt layer on the tire radial-direction outer side of a carcass; and
at least one belt reinforcing layer covering the full width of the belt on the tire radial-direction outer side of the belt,
wherein
the belt reinforcing layer comprises, as a constituent, a rubber-cord composite that is formed of a rubber and reinforcing cords comprising multifilaments of a semi-aromatic polyamide composed of a polycondensate of an aromatic dicarboxylic acid-containing dicarboxylic acid and a non-aromatic diamine, or a polycondensate of a non-aromatic dicarboxylic acid and an aromatic diamine-containing diamine, and
when the width of a maximum-width belt layer constituting the belt is defined as W, a region of at least more than 0.35 W from a tire equatorial plane is a sparse region in terms of the end count of the reinforcing cords in the belt reinforcing layer, while regions on the tire width-direction outer side of the sparse region are dense regions.

2. The tire according to claim 1, wherein the sparse region is in a range of 0.45 W or less from the tire equatorial plane.

3. The tire according to claim 1, wherein the semi-aromatic polyamide is a polycondensate of an aromatic dicarboxylic acid-containing dicarboxylic acid and a non-aromatic diamine.

4. The tire according to claim 1, wherein the non-aromatic diamine is at least one of an aliphatic diamine and an alicyclic diamine.

5. The tire according to claim 1, wherein the reinforcing cords taken out of the tire have a glass transition temperature of 80 to 230° C.

6. The tire according to claim 1, wherein the reinforcing cords taken out of the tire have a ratio between the dynamic elastic modulus E′ (100° C.) at 100° C. and the dynamic elastic modulus E′ (25° C.) at 25° C., E′ (100° C.)/E′ (25° C.), of 0.7 to 1.0.

7. The tire according to claim 1, wherein the reinforcing cords taken out of the tire have a water content of 0.1 to 2.0% by mass.

8. The tire according to claim 1, wherein the reinforcing cords taken out of the tire have a ratio between the loss tangent tan δ (25° C.) at 25° C. and the loss tangent tan δ (100° C.) at 100° C., tan δ (25° C.)/tan δ (100° C.), of 0.7 to 1.0.

9. The tire according to claim 1, wherein the loss tangent tan δ (25° C.) at 25° C. of the reinforcing cords taken out of the tire is 0.01 to 0.06.

10. The tire according to claim 1, wherein a ratio of the aromatic dicarboxylic acid with respect to the dicarboxylic acid in the reinforcing cords is 50% by mole or higher.

11. The tire according to claim 1, wherein a ratio of a dicarboxylic acid having one aromatic ring with respect to the aromatic dicarboxylic acid is 20% by mole or higher.

12. The tire according to claim 1, wherein a ratio of a dicarboxylic acid having two aromatic rings with respect to the aromatic dicarboxylic acid is 20% by mole or higher.

13. The tire according to claim 1, wherein a ratio of a dicarboxylic acid having three aromatic rings with respect to the aromatic dicarboxylic acid is 20% by mole or higher.

14. The tire according to claim 1, wherein a ratio of a diamine having 7 to 12 carbon atoms with respect to the diamine is 20% by mole or higher.

15. The tire according to claim 1, wherein the reinforcing cords are hybrid cords composed of multifilaments of the polyamide and at least one type of fibers selected from the group consisting of polyester fibers, nylon fibers, aramid fibers, polyketone fibers, glass fibers, carbon fibers, poly-p-phenylene benzobisoxazole fibers, and polyarylate fibers.

16. The tire according to claim 1, wherein the reinforcing cords taken out of the tire have a primary twist coefficient α1 and a final twist coefficient α2, which are represented by the following Formulae (1) and (2), of 0.1 to 0.9 and 0.1 to 1.2, respectively:
α1=N1×√(0.125×D1/ρ)×10⁻³ (1)
α2=N2×√(0.125×D2/ρ)×10⁻³ (2)
(wherein, N1 represents the number of primary twists [twists/10 cm], D1 represents the fineness [dtex] of a single primary-twisted yarn, N2 represents the number of final twists [twists/10 cm], D2 represents the cord total fineness [dtex], and p represents the density [g/cm³] of the reinforcing cords).

17. The tire according to claim 16, wherein the α1 is 0.1 to 0.5 and the α2 is 0.1 to 0.7.

18. The tire according to claim 1, wherein the total fineness of the reinforcing cords is 1,000 to 8,000 dtex.

19. The tire according to claim 16, wherein the number of primary twists N1 of the reinforcing cords is 10 to 30 twists/10 cm.

20. The tire according to claim 1, which is for a passenger vehicle.
